(19) United States
(12) Patent Application Publication
(10) Pub. No.: US 2025/0104733 A1
(43) Pub. Date: Mar. 27, 2025

(54) DISK DRIVE SUSPENSION

(71) Applicant: NHK SPRING CO., LTD., Yokohama-shi (JP)

(72) Inventors: Masao HANYA, Yokohama-shi (JP); Toshiki ANDO, Yokohama-shi (JP)

(73) Assignee: NHK SPRING CO., LTD., Yokohama-shi (JP)

(21) Appl. No.: 18/896,917

(22) Filed: Sep. 26, 2024

(30) Foreign Application Priority Data
Sep. 27, 2023 (JP) 2023-165901

(51) Int. Cl. G11B 5/48

(52) U.S. Cl. CPC G11B 5/4826; G11B 5/4833

(57) ABSTRACT

According to one embodiment, a suspension includes a load beam having a dimple portion and a flexure having a slider mounting portion. The dimple portion has a convex surface in contact with the slider mounting portion. The slider mounting portion is swingably supported by a gimbal component member. The radius of curvature of the convex surface is less than 0.15 mm. The flexure pitching resistance acting on the contact portion when the slider mounting portion swings in the pitching direction is 0.005 N or less. The phase delay of the slider mounting portion in the pitching direction relative to an undulation of a rotating disk is 200 or less.

### CROSS-REFERENCE TO RELATED APPLICATIONS

This application is based upon and claims the benefit of priority from prior Japanese Patent Application No. 2023-165901, filed Sep. 27, 2023, the entire contents of which are incorporated herein by reference.

### BACKGROUND OF THE INVENTION

### 1. Field of the Invention

The present invention relates to a disk drive suspension comprising a swingable slider mounting portion, on which a slider is mounted.

### 2. Description of the Related Art

For information processing devices such as personal computers, hard disk drives (HDD) are used. A hard disk drive includes a magnetic disk which rotates around a spindle, a carriage which rotates about a pivot axis and the like. The carriage comprises an arm portion. The carriage is pivoted about the pivot axis by a positioning motor such as a voice coil motor.

To the arm portion of the carriage, a disk drive suspension (hereinafter, referred to as a suspension) is attached. The suspension includes a load beam, a flexure provided along the load beam, and the like. A slider is mounted on a slider mounting portion formed near the distal end of the flexure. In this field, the slider mounting portion may aundulation be referred to as a tongue.

The load beam, the flexure, the slider and the like constitute a gimbal assembly. In the slider, an element for accessing such as data reading or writing is provided. When a disk drive is used, data access to the recording surface of the disk is performed by the elements of the slider while the disk is rotating.

For example, JP 2014-22013 A (Patent Literature 1) and JP 2020-140749 A (Patent Literature 2) describe examples of suspensions with a slider mounting portion. In this type of suspension, the convex surface of the dimple portion is brought into contact with the slider mounting portion. The dimple portion is provided on the load beam. The slider mounting portion is elastically supported by a gimbal component such as an outrigger. The slider mounting portion is swung about the convex surface of the dimple portion.

When a disk is rotated, air flows between the leading end of the slider and the trailing end of the slider. As a result, an air bearing is formed. The term “leading side” used in this specification is meant the side from which air flows between a slider and the respective disk when the disk is rotated. The “trailing side” is meant the side from which air flows out.

In order to accommodate the higher recording densities of disks, the distance between the slider and disk tends to become smaller. When the disk is rotated, the above-described air bearing is formed. For example, the distance between the leading end of the slider and the disk when the air bearing is formed is 100 nm. On the other hand, for example, the distance between the trailing end of the slider and the disk is 10 nm.

The recording surfaces of disks appear to be flat, but, in reality, undulations with an amplitude of around several micrometers may occur along the circumferential direction of the disks. The authors of the present invention closely examined the flatness of the disks. They found a tendency for the undulations located around the outer circumference of the disk to be greater as compared to the undulations located near the center clamp, which is closer to the center of rotation of the disk. Here, note that the slider must move in the pitching direction while following the undulations of the disk.

The slider is swung with respect to the load beam about the convex surface of the dimple portion as a fulcrum. In this specification, the behavior of the leading side portion of the slider moving away from or closer to the load beam along the longitudinal direction of the suspension is referred to as pitching. The pitch angle is the angle in the pitching direction from the reference position. In this specification, the movement of the leading portion of the slider in the direction of movement closer toward the load beam is referred to as “movement in the direction of a positive pitch angle”. The movement of the leading portion of the slider away from the load beam is referred to as “movement in the direction of a negative pitch angle”.

When the slider travels along the upward slope of undulations on the disk, the slider moves along the surface of the disk in the direction of the negative pitch angle. When the slider travels along the downward slope of undulations, the slider moves along the surface of the disk in the direction of the positive pitch angle.

The slider is inclined at a slightly positive pitch angle with respect to the surface of the disk. The pitch angle is generally very small, for example, 0.006°. If the amplitude of the undulations is, for example, 3 to 6 μm, the slider needs to move while changing in the pitching direction by quite a large angle, for example, +0.03 to +0.06°.

With the recent evolution of disk drives, the lengths of suspensions tend to shorten. The load beam is angled to some extent in the pitching direction relative to the disk surface. The slider mounting portion is located at the distal end of the load beam. This slider mounting portion moves in the pitching direction around the dimple portion with respect to the load beam. As the length of the suspension is shorter, the angular change of the slider in the pitching direction becomes larger. Here, for example, it is known that the angular change of the slider is large when the length of the suspension is close to 6 mm.

If the slider cannot follow the undulations of the disk quickly, the slider may approach the surface of the disk excessively. When the slider comes too close to the surface of the disk, it is known that friction is created between the slider and the disk or air bearing, which may cause hot spots. In extreme cases, the slider may come into contact with the disk and scratch the disk or slider.

The authors of the present invention have made intensity studies and found in some cases that a slider comes excessively close to a disk at a site where the pitch angle changes significantly. The pitch angle changes significantly near the apex of the undulations on the disk and near the bottom of the undulations. In order to avoid interference between the disk and the slider, the inventors have learned that the followability of the slider to undulations of the disk is important.

In the field of this technology, it is customary to consider that a slider mounting portion such as a tongue swings in contact with the convex surface of a dimple portion at practically a single point. The contact between the convex surface of the dimple portion and the slider mounting portion corresponds to the contact between a spherical surface rolling on a plane and the plane. Such contact has been considered as Hertzian elastic contact. In Hertzian elastic contact, the friction between the slider mounting portion (plane) and the convex surface (sphere) of the dimple portion can be practically ignored. Therefore, it has not been considered that the movement of the slider mounting portion is affected by the friction with the convex surface.

An object of one embodiment of the invention is to provide a suspension for a disk drive that can suppress interference between a rotating disk and a slider.

### BRIEF SUMMARY OF THE INVENTION

As a result of the inventors' intensive research, it was found that a force similar to friction, but in a direction opposite to the pitching direction, is generated at the contact portion between the convex surface of the dimple portion and the slider mounting portion. The inventors refers to this force as flexure pitching resistance (Fpr). The Fpr is an abbreviation for flexure pitching resistance.

The flexure pitching resistance (Fpr) is generated at the contact portion between the slider mounting portion and the convex surface when the slider mounting portion is swung above the convex surface of the dimple portion. Further, it has been found that the flexure pitching resistance (Fpr) may cause a phase delay in the slider when the slider mounting portion that follows the undulations of the disk swings. The behavior of the slider following the undulations of the disk was further studied. The results of the research showed that if the phase delay of the slider in the pitching direction relative to the undulation period is 20° or less, preferably 15° or less, the interference between the disk and the slider can be suppressed.

A disk drive suspension according to a first aspect comprises a load beam and a flexure disposed along the load beam and including a slider mounting portion on which a slider is mounted. The suspension includes a dimple portion and a gimbal component member. The dimple portion is formed on the load beam and has a convex surface in contact with the slider mounting portion. The gimbal component member supports the slider mounting portion in contact with the convex surface so as to be swingable in at least the pitching direction with respect to the load beam.

The radius of curvature of the convex surface is less than 0.15 mm and 0.04 mm or more, and the phase delay of the slider mounting portion in the pitching direction relative to the undulation of the rotating disk is less than 20°. Preferably, the radius of curvature of the convex surface should be less than 0.10 mm (for example, 0.095 mm) and the phase delay of the slider mounting portion is 15° or less. More preferably, the radius of curvature of the convex surface should be less than 0.085 mm.

A disk drive suspension according to a second aspect as well comprises a load beam, a flexure, a dimple portion, and a gimbal component member. The suspension is formed to have a flexure pitching resistance (Fpr) of 0.005 N or less and a phase delay of the slider mounting portion in the pitching direction relative to the undulation of the disk of 20° or less. The flexure pitching resistance (Fpr) acts on the contact portion between the convex surface of the dimple portion and the slider mounting portion.

In the suspension of the embodiments, preferably, the flexure pitching resistance (Fpr) should be 0.002 N or less and the phase delay of the slider mounting portion should be 10° or less. More preferably, the flexure pitching resistance (Fpr) should be 0.001 N or less and the phase delay of the slider mounting portion should be 5° or less. In the suspension of the embodiments, the radius of curvature of the convex surface may be less than 0.10 mm (for example 0.095 mm).

According to the suspension of the invention, it is possible to suppress the slider, which moves in the pitching direction while following the undulations of the rotating disk, from interfering with the disk.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view showing part a suspension according to one embodiment.

FIG. 2 is a cross-sectional view of a part of the suspension and a slider, taken along line F2-F2 in FIG. 1.

FIG. 3 is a cross-sectional view schematically showing an example of a disk drive.

FIG. 4 is a side view schematically showing a part of the suspension shown in FIG. 2, the slider and the disk.

FIG. 5 is a side view schematically showing the slider shown in FIG. 4 when it moves in a direction of a negative pitch angle.

FIG. 6 is a side view schematically showing the slider shown in FIG. 4 when it moves in a direction of a positive pitch angle

FIG. 7 is a schematic diagram representing the motion system of the suspension, slider, and disk shown in FIG. 4.

FIG. 8 is a diagram illustrating a position of the disk in an undulation cycle and the phase delay of the slider.

FIG. 9 is a diagram illustrating the relationship between a radius of curvature of a convex surface of a dimple portion and the phase delay of the slider.

FIG. 10 is a diagram illustrating the relationship between a flexure pitching resistance (Fpr) and the phase delay of the slider.

### DETAILED DESCRIPTION OF THE INVENTION

A suspension for a disk drive according to an embodiment will now be described with reference to the drawings. Hereafter, a disk drive suspension may be referred to simply as a suspension.

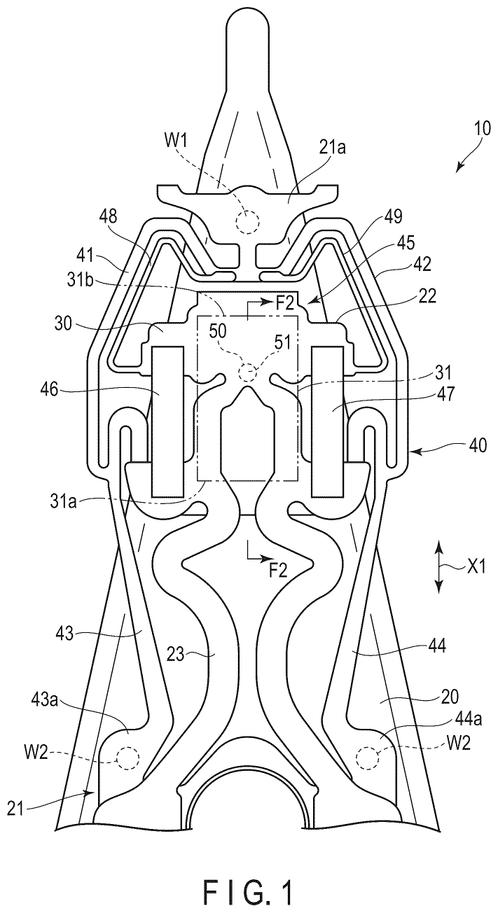

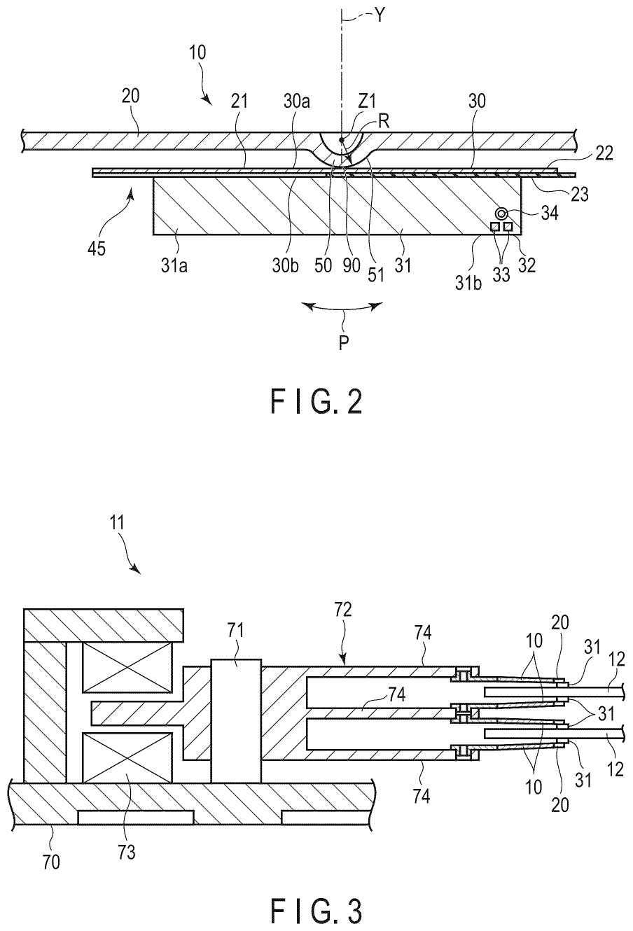

FIG. 1 is a plan view of a part of a suspension 10. FIG. 2 is a cross-sectional view of the part of the suspension 10 taken along line F2-F2 in FIG. 1. FIG. 3 is a cross-sectional view schematically showing a disk drive 11 including a suspension 10. The disk drive 11 contains one or more disks 12. The disk drive 11 will be described later, and the suspension 10 will be described first.

The suspension 10 includes a load beam 20 and a flexure 21 disposed along the load beam 20. The load beam 20 is made from a stainless steel plate and extends along the length of the suspension 10. The direction indicated by the two-way arrow X1 in FIG. 1 is the longitudinal direction of the load beam 20, that is, the longitudinal direction of the suspension 10. The thickness of the load beam 20 is, for example, 20 to 40 μm, but is not limited to this range.

The flexure 21 includes a metal base 22 made from a thin stainless steel plate and a wiring portion 23 disposed along the metal base 22. The thickness of the metal base 22 is, for example 20 μm (12 to 25 μm). The thickness of the metal base 22 is less than the thickness of the load beam 20.

As shown in FIG. 1, the metal base 22 is fixed to the load beam 20 by a plurality of weld portions (for example, a first weld portion W1 and a second weld portion W2). The wiring portion 23 includes a base insulation layer, a plurality of conductors, and a cover layer. The base insulating layer is made of an electrically insulating resin such as polyimide. The conductors are formed on the base insulating layer. The cover layer covers the conductors.

On a part of the metal base 22, a slider mounting portion 30 is formed. In the field of this technology, the slider mounting portion 30 may be referred to as a tongue in some cases. As shown in FIG. 2, the slider mounting portion 30 has a first surface 30a and a second surface 30b. The first surface 30a opposes the load beam 20. The second surface 30b is on an opposite side to the first surface 30a with respect to the thickness direction of the metal base 22.

On the second surface 30b of the slider mounting portion 30, a slider 31 is provided so as to interpose the wiring portion 23 therebetween. A part of the slider 31 is fixed to the slider mounting portion 30 by an adhesive. The slider 31 includes a leading side portion 31a and a trailing side portion 31b with respect to the rotational direction of the disk 12. The expression “leading side” used in this specification is the side from which air flows between the disk 12 and the slider 31 when the disk is rotated. The expression “trailing side” is the side from which air flows out.

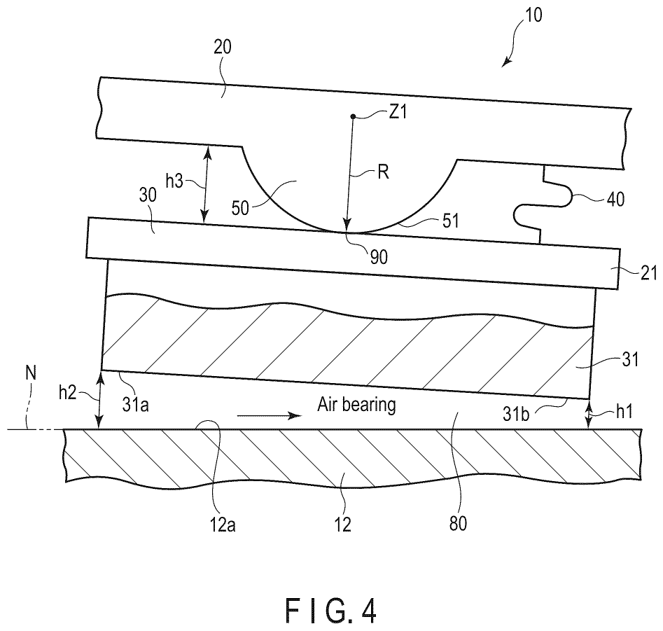

At the distal end 32 of the trailing side of the slider 31, a plurality of elements 33 are provided. These elements 33 can convert magnetic signals and electrical signals between each other as so in, for example, MR elements. These elements 33 are used to access the recording surface of the disk 12, for such as writing or reading of data. In the vicinity of the elements 33, a heater 34 may be disposed. When the heater 34 is energized, the trailing side portion 31b is heated and expands. As a result, the distance h1 (shown in FIGS. 4 to 6) between the trailing side portion 31b and the disk 12 can be further reduced. For example, it is possible to reduce the distance h1 to 1 nm or less.

The distance h1 between the trailing side portion 31b of the slider 31 and the disk 12 may as well be referred to as head media spacing (HMS) in some cases. The distance h1 is smaller than the distance h2 between the leading side portion 31a and the disk 12 (shown in FIGS. 4 to 6). More specifically, the distance h2 is, for example, 100 nm, whereas h1 is, for example, 10 nm.

As shown in FIG. 1, the slider mounting portion 30 is elastically supported on the load beam 20 by first arms 41 and 42 and second arms 43 and 44. The first arms 41 and 42 and the second arms 43 and 44 are examples of a gimbal component member 40. The first arms 41 and 42 and the second arms 43 and 44 are part of the metal base 22. The gimbal component members 40 may take various forms depending on the design of the flexure 21. Therefore, the gimbal component members 40 are not limited to those of the example shown in FIG. 1.

The slider mounting portion 30 and the gimbal component member 40 constitute a gimbal portion 45. The gimbal portion 45 of this embodiment is part of the flexure 21. On respective sides of the slider 31, actuator elements 46 and 47 may be disposed. The actuator elements 46 and 47 are each constituted by a piezoelectric material such as lead zircon titanate (PZT), for example. The actuator elements 46 and 47 can rotate the trailing side portion 31b of the slider 31 in the width direction of the slider 31 by a small amount when voltage is being applied.

The distal end sides of the first arms 41 and 42 are each supported on the load beam 20 by the first weld portion W1. The proximal portions 43a and 44a of the respective second arms 43 and 44 are fixed to the load beam 20 by the second weld portion W2. In other words, the slider mounting portion 30 is elastically supported so as to be swingable by the gimbal component member 40 with respect to the load beam 20.

Between the slider mounting portion 30 and the distal end portion 21a of the flexure 21, limiter members 48 and 49 may be provided. The limiter members 48 and 49 each are made of a resin such as polyimide. The limiter members 48 and 49 serve to prevent the slider mounting portion30 from swinging excessively when an external shock is input to the suspension 10. Depending on the design of the flexure 21, the limiter members 48 and 49 may be able to function as part of the gimbal component member 40.

A dimple portion 50 is formed on the load beam 20. As shown in FIG. 2, the dimple portion 50 has a convex surface 51 that protrudes in a dome shape toward the slider mounting portion 30. The convex surface 51 is shaped as an arc with a radius of curvature R rotated around a vertical axis Y. The convex surface 51 is approximately circular in plan view of the slider mounting portion 30. The arc of radius of curvature R is not necessarily of a perfect circle. In other words, the convex surface 51 has a shape resembling a part of a hemispherical surface. The vicinity of the top of the convex surface 51 is brought into contact with the first surface 30a of the slider mounting portion 30.

FIG. 2 shows a state where the convex surface 51 of the dimple portion 50 is brought into contact with the slider mounting portion 30. The slider mounting portion 30 swings at least in the pitching direction (the direction indicated by the arrow P in both directions in FIG. 2). Thus, in the slider mounting portion 30, displacement occurs in at least longitudinal around the convex surface 51 as its center. The slider mounting portion 30 is supported on the load beam 20 by the gimbal component member 40 such as outriggers and arms. The slider mounting portion 30 is swingable in at least the pitching direction (vertical rocking direction) and a rolling direction (horizontal rocking direction) with respect to the load beam 20.

FIG. 3 is a cross-sectional view schematically showing an example of a disk drive (HDD) 11. The disk drive 11 includes disks 12 which rotate around a spindle, a case 70 (only part of which is shown), a carriage 72 that can pivot around a pivot axis 71, a motor 73 for positioning which drives the carriage 72 and the like. The case 70 is sealed by a lid. The suspension 10 is attached to the distal end of an arm portion 74 of the carriage 72.

When the carriage 72 is pivoted by the positioning motor 73, the suspension 10 moves in the radial direction of the disk 12. As a result, the slider 31 moves to a predetermined position on the disk 12. As the disk 12 rotates, air flows from the leading side portion 31a toward the trailing side portion 31b of the slider 31. This air flow creates an air bearing 80 between the disk 12 and the slider 31.

FIG. 4 schematically represents a surface 12a of the disk 12 along an imaginary flat reference plane N, the slider 31, and the dimple portion 50. The slider mounting portion 30 is in contact with the convex surface 51 when elastically supported by the gimbal component member 40. With this configuration, the slider mounting portion 30 and the convex surface 51 are brought into contact with each other at the contact portion 90.

The slider mounting portion30 moves around the center of curvature Z1 as if rolling on the convex surface 51 while being in contact with the convex surface 51 at the contact portion 90. At this time, the convex surface 51 and the slider mounting portion 30 are placed essentially in elastic contact between a plane and a sphere (Hertzian elastic contact). Therefore, there is no slippage in the contact portion, and loss due to friction is considered to be practically unproblematic.

In reality, however, a force similar to friction acts on the contact portion 90 between the slider mounting portion30 and the convex surface 51. This force is the flexure pitching resistance Fpr discovered by the authors of the present invention. The flexure pitching resistance Fpr can be determined by analysis, depending on the design of the flexure 21 (mainly the design of the gimbal portion 45).

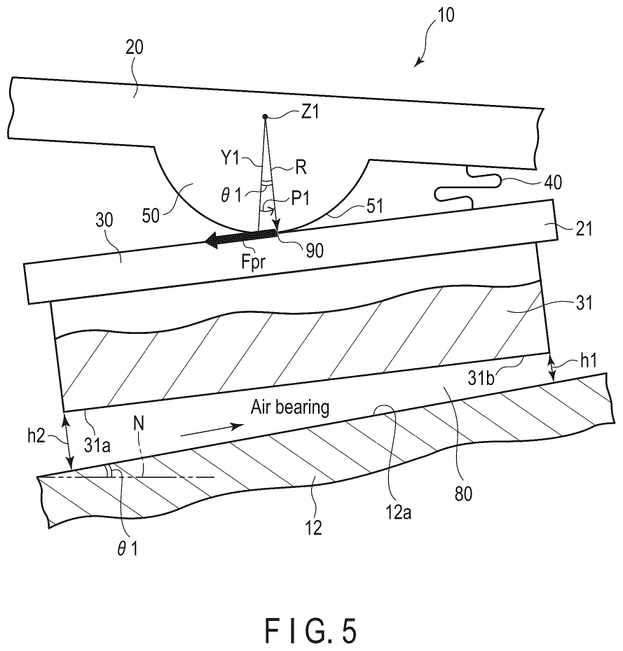

FIG. 5 schematically represents the slider 31 following up an upward slope of an undulation. The surface 12a of the disk 12 is at a negative pitch angle θ1 with respect to the reference plane N. As shown in FIG. 5, the slider 31 follows up the undulation of the disk 12. Accordingly, the contact portion 90 between the slider mounting portion 30 and the convex surface 51 moves from the reference line Y1 to the first direction P1. The slider mounting portion 30 rolls over the convex surface 51 substantially without slipping. At this time, in the contact portion 90, a flexure pitching resistance Fpr is generated in an opposite direction to the direction in which the slider mounting portion 30 moves. The flexure pitching resistance Fpr acts in the tangential direction of the convex surface 51.

The flexure pitching resistance Fpr acts on the contact portion 90 as a moment of the curvature radius R. Therefore, the torque around the center of curvature Z1 acts on the slider mounting portion 30. The torque around the center of curvature Z1 is expressed as the product of the flexure pitching resistance For and the radius of curvature R (For×r). Here, as the radius of curvature R is larger, the torque becomes greater. This torque imparts resistance to the movement of the slider mounting portion30 in the pitching direction.

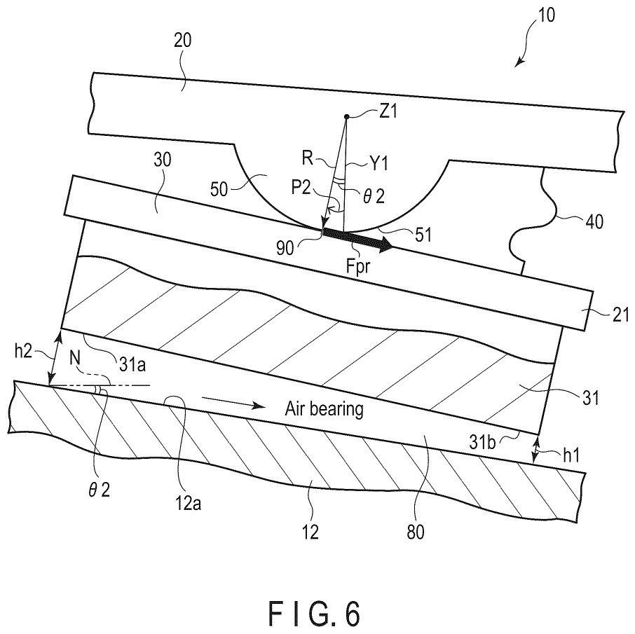

FIG. 6 schematically represents a state where the slider 31 follows up an undulation of a positive pitch angle θ2. The slider mounting portion 30 and the convex surface 51 are in contact with each other at the contact portion 90. When the slider 31 follows the undulation of the positive pitch angle θ2, the contact portion 90 moves from the reference line Y1 to the second direction P2. The slider mounting portion 30 rolls over the convex surface 51 without substantial slippage. At this time, a flexure pitting resistance Fpr in a direction opposite to the direction in which the slider mounting portion 30 moves acts on the contact portion 90 in the tangential direction of the convex surface 51.

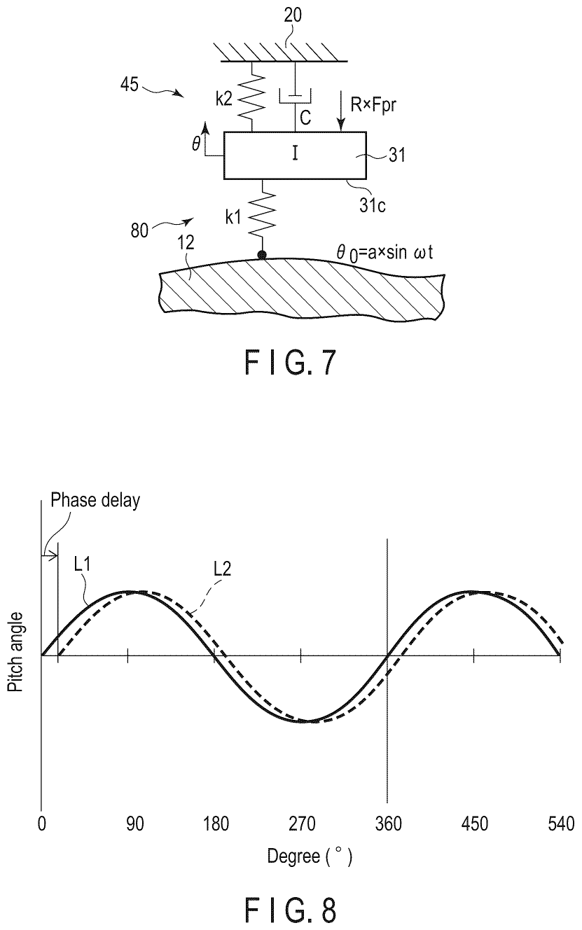

FIG. 7 is a diagram schematically showing a motion system including the slider 31. In FIG. 7 and the formulas which will be provided hereinafter, k1 represents a stiffness in the pitch direction (pitch stiffness) [Nm/rad] of the slider surface 31c facing the air bearing 80. A symbol, k2 represents a pitch stiffness [Nm/rad] of the gimbal portion 45. A symbol, C represents a viscous damping coefficient between the slider surface 31c facing the air bearing 80 and the gimbal portion 45. A symbol, ζ represents a viscous damping ratio. A symbol, θ is a pitch angle [rad], “a” represents an input amplitude [rad], Fpr represents a flexure pitching resistance [N], R represents a radius of curvature R [m], and ω represents a circular vibration frequency [rad/s]. A symbol, I represents an inertia of the slider 31 including the slider mounting portion 30. Note here that, as for I, only the inertia of the slider 31 is considered in order to simplify the calculation.

Here, the equation of motion when a forced vibration of θ₀ is input as the undulation of the disk 12 is expressed as:

$$I \times {θ}^{″} = - k 1 \times ( θ - a \times sin ω t ) - C \times {θ}^{′} - k 2 \times θ - R \times Fpr .$$

When this equation is transformed, the following Formula 1 is obtained:

$${θ}^{″} + C / I \times {θ}^{′} + ( k 1 + k 2 ) / I \times θ = a \times k 1 / I \times sin ω t - R \times Fpr / I \qquad Formula 1$$

Here, when

$$ω 0 = \sqrt{( k 1 + k 2 ) / I} , ζ = C / 2 / \sqrt{I \times ( k 1 + k 2 )}$$

the following formulas are derived.

$$( k 1 + k 2 ) / I = ω {0}^{2} , C / I = 2 \times ζ \times ω 0$$

Therefore, Formula 1 can be expressed as:

$${θ}^{″} + 2 \times ζ \times ω 0 \times {θ}^{′} + ω {0}^{2} \times θ = a \times k 1 / I \times sin ω t - R \times Fpr / I \qquad Formula 2$$

The steady-state response of the equation of motion: θp=U×sin ωt+V×cos ωt can be expressed by the following formula 3 to formula 8.

$$U = \frac{a \times k 1 \times ( ω {0}^{2} - {ω}^{2} ) - 2 \times ζ \times ω 0 \times ω \times R \times Fpr}{I \times \{ {( ω {0}^{2} - {ω}^{2} )}^{2} + {( 2 \times ζ \times ω 0 \times ω )}^{2} \}} \qquad Formula 3$$

$$- V = \frac{R \times Fpr \times ( ω {0}^{2} - {ω}^{2} ) + 2 \times ζ \times ω 0 \times ω \times a \times k 1}{I \times \{ {( ω {0}^{2} - {ω}^{2} )}^{2} + {( 2 \times ζ \times ω 0 \times ω )}^{2} \}} \qquad Formula 4$$

$$θ p = U \times sin ω t + V \times cos ω t = A \times sin ( ω t - δ ) \qquad Formula 5$$

$$A = \sqrt{{U}^{2} + {V}^{2}} \qquad Formula 6$$

$$δ = {tan}^{- 1} ( - V / U ) \qquad Formula 7$$

$$Gain = A / a \qquad Formula 8$$

By Formula 3 to Formula 8, the response of the pitching of the slider with respect to the undulation of the disk can be calculated. When ζ=0, the following formula can be obtained.

$$\begin{matrix}U = \frac{a \times k 1}{I \times ( ω {0}^{2} - {ω}^{2} )} & - V = \frac{R \times Fpr}{I \times ( ω {0}^{2} - {ω}^{2} )} \\ A = \frac{\sqrt{{a}^{2} \times k {1}^{2} + {R}^{2} \times {Fpr}^{2}}}{I \times ( ω {0}^{2} - {ω}^{2} )} & δ = {tan}^{- 1} ( \frac{R \times Fpr}{a \times k 1} )\end{matrix}$$

From the formulas for the case where there is no viscous damping, the following can be found.

(1) When there is a flexure pitching resistance Fpr, phase delay & occurs regardless of frequency.

(2) The parameters of the phase delay d are the radius of curvature R of the dimple convex surface, the flexure pitching resistance Fpr, the input amplitude a, and the pitch stiffness k1 of the air bearing.

(3) In particular, when the undulation of the disk is 10 μm or less, the input amplitude a is at the minimal, and therefore it can be inferred that the phase delay increases.

As described above, the flexure pitching resistance Fpr produces such a force as just friction on the contact portion 90. Therefore, a phase delay is caused in the slider mounting portion 30 that moves in the pitching direction while following the undulations of the disk 12. The term “phase delay” used here refers to the delay in position during a cycle when one cycle is 360° with respect to a phenomenon that occurs periodically, such as the undulation of a rotating disk 12. In other words, it is the difference in phase between the period of undulation of the disk 12 and the period of movement of the slider 31 in the pitching direction.

FIG. 8 schematically shows the relationship between the position during the cycle of the undulation of the disk 12 and the pitch angle of the slider 31. A phase delay (shown by the dashed line L2 in FIG. 8) occurs in the slider 31 with respect to the undulation cycle (shown by the solid line L1 in FIG. 8). When a phase delay occurs in the slider 31 with respect to the undulation of disk 12, there is a delay in the following-up of the slider 31 with respect to the undulation. If the phase delay of the slider becomes large, there is a possibility that the slider 31 and the disk 12 may interfere with each other.

The authors of the present invention made intensive studies and found that there was an interference caused by an excessive proximity of the slider to the disk at locations where the change in the pitch angle of the undulation is large. Sites where a large change in pitch angle of undulation is created are near apexes of wave crests of an undulation and near bottoms of waves of an undulation of the disk. The slider follows the undulations of the rotating disk. Here, in order to suppress interference between the disk and the slider, it was further found to be effective to reduce the phase delay of the slider in the pitching direction to 20° or less, preferably 15° or less. Thus, to prevent interference between the disk and the slider, it is recommended that the phase delay of the slider relative to the undulation period should be 20° or less, preferably 15° or less.

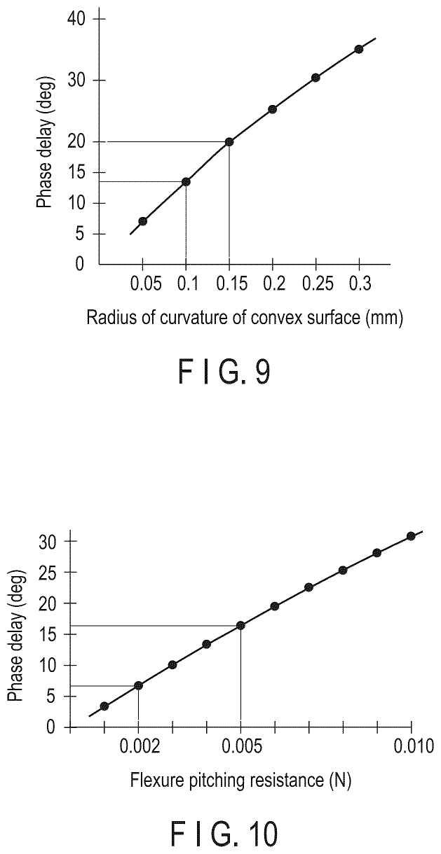

FIG. 9 represents the relationship between the radius of curvature R of the convex surface 51 and the phase delay of the slider 31. Here the parameters are as follows.

$$I = 3.15 E - 14 [ kg {m}^{2} ] , a = 5.24 E - 4 [ rad ] ( approximate value 0.03 deg ) , R = 2.5 E - 4 [ m ] ( 0.25 mm ) , k 1 = 8. E - 3 [ Nm / rad ] , k 2 = 7.2 E - 6 [ Nm / rad ] , Fpr = 0.01 [ N ] ( approximate value 1 gf ) , and ζ = 0.02$$

When the radius of curvature R of the convex surface 51 is less than 0.15 mm, the phase delay can be made smaller than 20°. But, it is practically difficult to make the radius of curvature R smaller than 0.04 mm due to the limitations of the die used to form the dimple portion 50. Therefore, the radius of curvature R should be set to less than 0.15 mm and greater than 0.04 mm. The height h3 of the dimple portion (shown in FIG. 4) is, for example, from 0.04 mm to 0.07 mm, but may be some other height.

When the radius of curvature R of the convex surface 51 is less than 0.10 mm, the phase delay of the slider 31 can be made less than 15°. Therefore, less than 0.10 mm of a curvature radius R is more effective in suppressing interference with the disk. When the radius of curvature R of the convex surface 51 is less than 0.085 mm, the phase delay can be reduced to nearly 10°.

FIG. 10 is a diagram illustrating the relationship between the flexure pitching resistance (Fpr) and the phase delay of the slider. When the flexure pitching resistance (Fpr) is 0.005 N or less, the phase delay of the slider that follows up the undulation of the disk can be reduced to 20° or less. Even more preferably, the flexure pitching resistance (Fpr) should be set to 0.002 N or less, and thus the phase delay of the slider can be made 10° or less.

Preferably, the flexure pitching resistance (Fpr) should be 0.001 N or less and thus the phase delay of the slider can be made 5° or less. In suspensions having a flexure pitching resistance (Fpr) of 0.005 N or less, the radius of curvature R of the convex surface 51 may be less than 0.10 mm.

In implementing the present invention, it goes without saying that the respective components of the suspension can be changed in various ways, including the specific modes, that is, shape and position of the load beam, flexure, slider, and dimple portion. The disk drive as well is not restricted to the aforementioned embodiments, but can take various forms as needed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk drive suspension comprising:
a load beam;
a flexure disposed along the load beam and including a slider mounting portion on which a slider is mounted;
a dimple portion formed on the load beam and including a convex surface in contact with the slider mounting portion;
a gimbal component member which supports the slider mounting portion in contact with the convex surface so as to be swingable in at least a pitching direction,
wherein
the convex surface has a radius of curvature of less than 0.15 mm and 0.04 mm or greater, and
a phase delay of the slider mounting portion in the pitching direction with respect to an undulation of a rotating disk is 20° or less.

2. The suspension of claim 1, wherein
the radius of curvature of the convex surface is less than 0.10 mm, and
the phase delay of the slider mounting portion is 15° or less.

3. The suspension of claim 1, wherein
the radius of curvature of the convex surface is less than 0.085 mm, and
the phase delay of the slider mounting portion is 15° or less.

4. A disk drive suspension comprising:
a load beam;
a flexure disposed along the load beam and including a slider mounting portion on which a slider is mounted;
a dimple portion formed on the load beam and including a convex surface in contact with the slider mounting portion;
a gimbal component member which supports the slider mounting portion in contact with the convex surface so as to be swingable in at least a pitching direction,
wherein
a flexure pitching resistance acting on a contact portion between the slider mounting portion and the convex surface when the slider mounting portion moves in the pitching direction is 0.005 N or less, and
a phase delay of the slider mounting portion in the pitching direction relative to an undulation of a rotating disk is 20° or less.

5. The suspension of claim 4, wherein
a flexure pitching resistance is 0.002 N or less, and
the phase delay of the slider mounting portion is 10° or less.

6. The suspension of claim 4, wherein
the flexure pitching resistance is 0.001 N or less; and
the phase delay of the slider mounting portion is 5° or less.

7. The suspension of claim 4, wherein
the radius of curvature of the convex surface is less than 0.10 mm.
